(19) United States
(12) Patent Application Publication
(10) Pub. No.: US 2025/0360979 A1
(43) Pub. Date: Nov. 27, 2025

(54) DEVICE FOR MOVING ON A GRANULAR MEDIUM

(71) Applicant: CROVER LTD, Edinburgh, Lothian (GB)

(72) Inventors: Artem LUKIANOV, Edinburgh (GB); James John MCGINLEY, Edinburgh (GB); Joel KEISHING, Edinburgh (GB); Corentin CHAUVIN-HAMEAU, Edinburgh (GB); Veghell Leo ACUNA, Edinburgh (GB); Nathaniel Matthew BALL, Edinburgh (GB); Skriptyan Noor Hidayatullah SYUHRI, Jember (ID); Lorenzo CONTI, Edinburgh (GB); Gianlorenzo DE SANTIS, Edinburgh (GB)

(73) Assignee: CROVER LTD, Edinburgh, Lothian (GB)

(21) Appl. No.: 19/146,307

(22) PCT Filed: Jan. 19, 2024
(86) PCT No.: PCT/GB2024/050159

§ 371 Date: Jul. 8, 2025

(30) Foreign Application Priority Data
Jan. 20, 2023 (GB) 2300890.7

(51) Int. Cl. B62D 57/036; B62D 57/024

(52) U.S. Cl. CPC B62D 57/036; B62D 57/024

(57) ABSTRACT

A device for moving on a granular medium including one or more slopes. The device includes: a body having a front and rear in longitudinal direction; and one or more rotatable parts, each for rotational movement relative to body about respective rotational axis having component aligned with longitudinal direction, and being externally-exposed to adjacent portion of granular medium wherein device is provided. The one or more rotatable parts includes one or more helical fins extending outward from rotational axis, wherein rotation of one or more rotatable parts is configured to cause movement of device on granular medium. A first longitudinal distance between centre of mass of device and front of the body is less than a second longitudinal distance between, expected centre of contact between device and granular medium when device is on flat portion of granular medium, and front of body.

### FIELD OF THE INVENTION

The present invention relates to a device for moving on a granular medium, and a method of surveying sub-surface environmental properties of granular medium using the same.

### BACKGROUND TO THE INVENTION

Devices for moving through a granular medium is known and described, such as in UK patents GB2567898B and GB2599081B.

In order to measure environmental properties below the surface of the granular medium, known devices burrow the whole device through the granular medium to the required location.

Additionally, many granular medium environments include steep slopes, which can be difficult to navigate on the surface, without causing excessive slippage, and/or landslides down the slopes of the granular medium.

It is in this context that the present inventions have been devised.

### SUMMARY OF THE INVENTION

In accordance with an aspect of the present invention, there is provided a device for moving on a granular medium including one or more slopes. The device comprises: a body having a front and a rear in a longitudinal direction; and one or more rotatable parts, each for rotational movement relative to the body about a respective rotational axis having a component aligned with the longitudinal direction, and being externally-exposed to an adjacent portion of a granular medium on which the device is to be provided. The one or more rotatable parts each comprise one or more helical fins extending outward from the rotational axis, such that rotation of the one or more rotatable parts is configured to cause movement of the device on the granular medium. A first longitudinal distance between a centre of mass of the device and the front of the body is less than a second longitudinal distance between, an expected centre of contact between the device and the granular medium when the device is on a flat portion of granular medium, and the front of the body.

Thus, by having a device where the centre of mass is relatively forwards, this ensures that the front of the device remains in contact with the granular medium, providing better traction on the slopes when moving uphill. In some examples, it may be that the device can be reconfigured so as to alter the centre of mass, and the centre of mass only be further forward than the centre of contact in fewer than all of the configurations. In other words, it may be that the device is configurable such that the first longitudinal distance between the centre of mass of the device and the front of the body is less than the second longitudinal distance between, the expected centre of contact between the device and the granular medium when the device is on a flat portion of granular medium, and the front of the body, instead of the device always exhibiting such a property in all configurations. Indeed, the device may be configurable into a first configuration in which the first longitudinal distance between the centre of mass of the device and the front of the body is less than the second longitudinal distance between, the expected centre of contact between the device and the granular medium when the device is on a flat portion of granular medium, and the front of the body, and a second configuration in which the first longitudinal distance is greater than the second longitudinal distance, such as by changing the centre of mass. In the second configuration, the device is particularly well suited for moving downhill on slopes.

The term “centre of contact” means the average contact location if the average is taken for each location which would be expected to be in contact with the granular medium when the device is on a flat portion of the granular medium. Specifically, the centre of contact is not limited to contact points between the one or more rotatable parts and the granular medium, but also takes account of any contact between other portions of the device, such as parts of the body, and the granular medium.

The term “centre of mass” means the point through which the mass of the device acts. In other words, if the device was supported at the point, substantially no rotational moments would be exerted on the device to cause the device to rotate.

It will be understood that a granular medium is substantially any medium comprising a plurality of solid grains. The granular medium may be grain. The granular medium may be sand. The granular medium may be flour. The granular medium may be salt. The granular medium may be sugar. The granular medium may be cement. The granular medium may be gravel. The granular medium may be fertiliser. The granular medium may be biomass. The granular medium may be lithium powder. Typically, the granular medium is capable of forming slopes, thereby presenting navigation challenges as described herein.

It will be understood that a helical fin includes fins including at least one complete contiguous rotation around the rotational axis, as well as fins having fin tips which each define only a portion of a single revolution of a helix. For example, a propeller may be considered to include a plurality of helical fins. Importantly, rotation of the one or more rotatable parts about the rotational axis causes movement of the one or more rotatable parts relative to the granular medium in a direction substantially parallel to the rotational axis (or to a resultant combined direction of the rotational axes, if different).

It may be that the slopes over which the device is capable of moving include slopes over 20 degrees, such as over 30 degrees, for example over 40 degrees.

A difference between the first longitudinal distance and the second longitudinal distance may be at least five percent of the distance between the front of the body and the rear of the body. Thus, the centre of mass is more than negligibly further forward than the centre of contact. The difference may be at least ten percent of the distance between the front of the body and the rear of the body. The difference may be at least 20 percent of the distance between the front of the body and the rear of the body. The difference may be less than 50 percent of the distance between the front of the body and the rear of the body.

The one or more rotatable parts may comprise a first rotatable part on a first lateral side of the body, and a second rotatable part on a second lateral side of the body. The respective rotational axes of the first and second rotatable parts may be mutually symmetric about a longitudinal vertical central plane of the body. Thus, there may be at least two rotatable parts, one on each lateral side of the device, making it easier to control steering of the device. It may be that the one or more rotatable parts is no more than four rotatable parts. It may be that the one or more rotatable parts is no more than two rotatable parts.

A pitch of the helical fins and the rotational direction of the first and second rotatable parts about their respective rotational axes may each be arranged such that the granular medium is moved laterally away from a central region beneath the device during forward movement of the device over the granular medium. Thus, grains of granular medium are less likely to become trapped between the first and second rotatable parts, restricting effecting movement of the device.

The device may further comprise a sensor for sensing an environmental property of the granular medium at a location below the surface. Thus, important properties of the granular medium can be measured. The sensor may be for local sensing of the environmental property in a region of the granular medium in contact with and/or adjacent to the sensor. In other words, it may be that the device is configured to locate the sensor below the surface of the granular medium.

The sensor may comprise a temperature sensor. Additionally or alternatively, the sensor may comprise a moisture sensor. The environmental property may include temperature. The environmental property may include moisture level. Thus, the state of the granular medium can be monitored easily using the device.

In some examples, the device may further comprise a sampling component configured to extract a sample of the granular medium from a location below the surface. In some examples, the device may further comprise a topical intervention component configured to deliver at least one of cold/hot air, pesticides, antifungals/insecticides, vibratory action and sound to the granular medium at the location below the surface.

The device may further comprise a deployable probe configured to be movable between a retracted configuration out of the granular medium and a deployed configuration. Typically, in the deployed configuration, at least a deployable portion of the deployable probe is within the granular medium. Thus, the deployable probe can be moved out of the granular medium to make it easier to move the device between locations, and then deployed into the granular medium as necessary.

This in itself is believed to be novel and so, in accordance with another aspect of the present invention, there is provided a device for moving on a granular medium including one or more slopes. The device comprises: a body having a front and a rear in a longitudinal direction; and one or more rotatable parts, each for rotational movement relative to the body about a respective rotational axis having a component aligned with the longitudinal direction, and being externally-exposed to an adjacent portion of a granular medium on which the device is to be provided. The one or more rotatable parts each comprise one or more helical fins extending outward from the rotational axis, such that rotation of the one or more rotatable parts is configured to cause movement of the device on the granular medium. The device further comprises a deployable probe configured to be movable between a retracted configuration out of the granular medium and a deployed configuration. Typically, in the deployed configuration, at least a deployable portion of the deployable probe is within the granular medium.

The sensor may be provided at the deployable portion of the deployable probe. The sampling component may be provided at the deployable portion of the deployable probe. The topical intervention component may be provided at the deployable portion of the deployable probe.

The deployable probe may be configured to be movable into a substantially vertical orientation, such that the deployable portion of the deployable probe is able to penetrate into the granular medium in a substantially vertical direction. Thus, the stability of the device is improved, even with any slippage of the granular medium and/or during deployment of the deployable portion into the granular medium. The deployable portion of the deployable probe may be configured to be rotatable about an axis parallel to a plane defined by longitudinal and lateral directions of the device. In other words, the deployable portion of the deployable probe may be rotated so as to be moved towards a vertical arrangement. In some examples, this ensures that the deployable portion of the deployable probe can be more vertical than would otherwise be the case when the device is on a sloped surface, such as on an uphill or downhill incline. In other examples, it can allow the deployable portion to be rotated between a retracted configuration in which the deployable portion is substantially flat against the device, and a deployed configuration in which the deployable portion is arranged to probe the granular medium. Thus, the device can be inserted into contained spaces, such as grain silos, through constricted openings, and later reconfigured into an operating configuration by rotation of the deployable portion of the deployable probe, thereby allowing for larger devices to be inserted into such spaces than would otherwise be possible.

The deployable portion of the deployable probe may be mounted to the device via a multi-axis gimbal. In this way, the deployable portion can be maintained substantially vertically regardless of the incline and direction of incline of the granular medium on which the device is provided. The multi-axis gimbal may be passive or active. In other words, the multi-axis gimbal may be resiliently biased towards a position in which the deployable portion is maintained substantially vertically, without a motor. In other embodiments, the multi-axis gimbal may be active, in that the device may comprise one or more motors to urged the deployable portion towards a vertical orientation via the multi-axis gimbal.

It will be understood that any of the components of the device may be mounted to the device via the multi-axis gimbal or via any other rotatable part. For example, the sampling component may be mounted to the device via the multi-axis gimbal, or via any other rotatable part to allow reorientation of the sampling component relative to the surface of the granular medium on which the device is provided.

The device may further comprise a deployment mechanism configured to cause the deployable probe to move between the retracted configuration and the deployed configuration. The deployment mechanism may be configured to cause the deployable probe to move from the retracted configuration towards the deployed configuration. The deployment mechanism may alternatively or additionally be configured to cause the deployable probe to move from the deployed configuration to the retracted configuration.

The deployment mechanism may comprise an electric motor. The electric motor may be in geared relationship with the deployable probe. Thus, movement of the deployable probe is caused by operation of the electric motor.

The deployment mechanism may further comprise a position sensor to measure a deployment parameter indicative of a deployment depth of the deployable portion of the deployable probe. The position sensor may be a potentiometer. The position sensor may be an encoder. Where the position sensor is a potentiometer, the deployment parameter may be an electrical resistance of the potentiometer. Thus, even where slippage occurs in the gearing between the electric motor and the deployable portion of the deployable probe, it is still possible to measure a deployment depth of the deployable portion. The deployable portion may be fixedly connected to a flexible member for coiling around a spool, where an axle of the spool is connected to a wiper of the potentiometer. In this way, the resistance of the potentiometer varies in dependence on the rotational position, including the number of rotations, of the spool. Typically, the potentiometer is a multi-turn potentiometer. In other words, the resistive track of the potentiometer may be arranged in a multi-cycle helix, and/or using a worm gear relationship, allowing for more than one complete rotation of the wiper between the lowest resistance and the highest resistance.

The deployable probe may define one or more suction inlets in fluid communication with a suction supply of the device, arranged to draw the deployable probe into the granular medium. Thus, it is easier to move the deployable probe into the deployed configuration, even where the granular medium is densely packed. The device May comprise the suction supply.

The deployable probe may comprise a propulsion component for propelling the deployable probe within the granular medium. Thus, the deployable probe can propel itself to the required location within the granular medium. The propulsion component may comprise one or more rotatable components arranged to cause movement of the deployable probe through the granular medium. It may be that the deployable probe is releasably and re-attachably attached to the rest of the device.

At least one of the one or more rotatable parts may comprise a central core from which the one or more helical fins extend. The central core may have a radius transverse to the axis of rotation of greater than a radial extent of the one or more helical fins from the central core. The radial extent of the one or more helical fins from the central core may be at least 10 millimetres. The radial extent of the one or more helical fins may be less than 100 millimetres. The central core may be substantially hollow. Thus, the central core can reduce a tendency of the device to sink beneath a surface of the granular medium in operation.

The central core may comprise a first end region and a second end region and a central region therebetween. A radial extend of the central region may be greater than a radial extent of either of the first end region and the second end region. Thus, the central core has a substantially bowed shape.

The device may further comprise one or more skids to support the body on the granular medium. The one or more skids may be arranged at a front of the body. The one or more rotatable parts may be arranged rearwards of the skids. It may be that the rotational axis of each of the one or more rotatable parts is longitudinally aligned with at least one of the one or more skids. The one or more skids may be two skids. The one or more skids may comprise a first skid on a first lateral side of the body, and a second skid on a second lateral side of the body. The skid may comprise a front portion having an upturned end. Thus, the skid is arranged to resist burrowing of the front of the device into the granular medium.

The device may be configured to be connected to an external support component and/or power supply via a tether. The device may comprise a tether attachment at the front of the body, arranged to route the tether to the rear of the body, beneath the body of the device. The tether attachment is configured to secure the tether at the front of the body. Thus, a pulling force on the tether at the point at which the tether is beneath the device, in the direction of the rear of the device, causes a downward force to be exerted on the front of the body via the tether attachment. During uphill movement of the device, this downward force improves the traction of the device on the granular medium, allowing the device to operate effectively on greater degrees of slope.

Similarly, during downhill movement of the device, there is a moment applied by the tension force in the tether, which provides an upward force to the front of the body, so as to resist burrowing of the device into the granular medium.

The device comprises a handle. The handle may be provided at a rear of the device. The handle may be an open handle. It may be that the tether is arranged to pass through an opening forming the handle.

The device may further comprise one or more motors configured to cause movement of the one or more rotatable parts. The one or more motors may be located in a front portion of the body. Thus, the mass of the one or more motors can help to ensure that the centre of mass is further forward than the centre of contact.

It will be understood that the front portion of the body may sometimes be considered as substantially the front half of the body. In other examples, the front portion may be considered anything forward of the longitudinal centre of the one or more rotatable parts. Similarly, a rear portion of the body may sometimes be considered as substantially the rear half of the body. In other examples, the rear portion may be considered anything rearward of the longitudinal centre of the one or more rotatable parts.

The device may further comprise a controller. The controller is configured to control operation of the device, such as operation of the one or more rotatable parts, and the deployable probe, where provided. The control of the operation of the device may be in response to control inputs received by the device. The control inputs may be received via wired or wireless communication from a user-operable control device.

The controller may comprise one or more processors and a memory configured to store instructions which when executed by the one or more processors cause the device to carry out the functions of the controller described herein. The memory may be non-transitory, computer readable memory. The memory may have the instructions stored thereon. The present invention extends to a non-transitory computer-readable medium (e.g. memory) having the instructions stored thereon to control the device as described herein. The memory may be solid-state memory. The controller may be provided in a single unit. In other example, the controller may be distributed, having a plurality of processors. A first processor may be separated from a second processor in a distributed manner. Where the controller is distributed over multiple separate devices, the device may be an apparatus, formed from a plurality of separate devices.

The present invention extends to a method of surveying an environmental property of a granular medium at one or more locations below the surface of the granular medium. This is applicable to versions of the device having the sensor as described hereinbefore. The method comprises: providing the device; operating the device to move the device over the granular medium to one or more locations; and outputting the sensor output of the device indicative of the environmental property of the granular medium below the surface at the one or more locations.

When the device comprises the deployable probe described hereinbefore, the method may further comprise deploying the deployable probe at each of the one or more locations.

The method may further comprise moving one or more components of the device frontwards and/or rearwards, whereby to alter a centre of mass of the device. The one or more components may be caused to move by operation of an electrical motor of the device. The one or more components may include the controller.

Thus, it will be understood that the centre of mass of the device can change. For example, when moving uphill it can be substantially towards the front. When moving downhill the centre of mass can be substantially towards the back, in which case the distance between centre of mass and the front may be longer than between the centre of contact and the front.

It may be that when moving on flat surface the centre of mass is located close to the centre of contact. Thus, the device exhibits good traction on flat surfaces too.

The reconfiguration of centre of mass can happen by moving one or more components. The one or more components may comprise dedicated payloads (weights) specifically to be used to alter the centre of mass. The one or more components may comprise one or more parts of the deployable probe. Thus, existing components of the device can be moved to change the centre of mass.

The one or more components may be moved in a direction parallel to the rotational axis of the one or more rotating parts. The one or more components may be moved in a direction parallel to a direction between the front and the rear of the body. The one or more components may be moved in a direction perpendicular to the aforementioned directions, such that the one or more components can be moved in a two-dimensional plane. The direction perpendicular to the aforementioned directions may be in a direction two lateral sides of the device (e.g. side to side). The device may be configured to alter a position of the centre of mass, by movement of the one or more components.

By allowing the centre of mass to move in this way, the device may be more stable and have better traction especially when moving up, down or even laterally along steep slopes in the granular medium.

In some examples, the device can be configured to alter a vertical position of the centre of mass, for example away from the surface of the granular medium or closer to the surface of the granular medium. This may be done by adjusting the angle at which arms supporting the one or more rotating parts are attached to the body of the device.

This may be especially helpful when the same device needs to be used in multiple granular mediums, having different densities; some granular mediums may be more dense and the device will not sink much, which means less than half of the one or more rotating parts will be submerged below the surface of the granular medium. Other granular mediums may be less dense, which means more than half of the one or more rotating parts will be submerged below the surface of the granular medium. In relatively dense granular mediums, the arms can be positioned in such a way forming a larger distance between at least two rotating parts and keeping clearance between the surface of the granular medium and the body low. In relatively less dense granular mediums, the arms can be positioned in such a way forming a closer distance between at least two rotating parts and raising the device further above the surface of the granular medium providing clearance between the granular medium and the body.

The controller may be configured to carry out the method as described herein.

### DESCRIPTION OF THE DRAWINGS

An example embodiment of the present invention will now be illustrated with reference to the following Figures in which:

FIGS. 1 and 2 show an example of a device according to the present invention;

FIG. 3 shows another example of a device according to the present invention;

FIG. 4 shows a schematic illustration of control components of a device according to the present invention;

FIG. 5 is a flowchart illustrating a method according to the present invention;

FIGS. 6 and 7 show further examples of devices according to the present invention; and

FIGS. 8 and 9 show still further examples of a device according to the present invention.

### DETAILED DESCRIPTION OF AN EXAMPLE EMBODIMENT

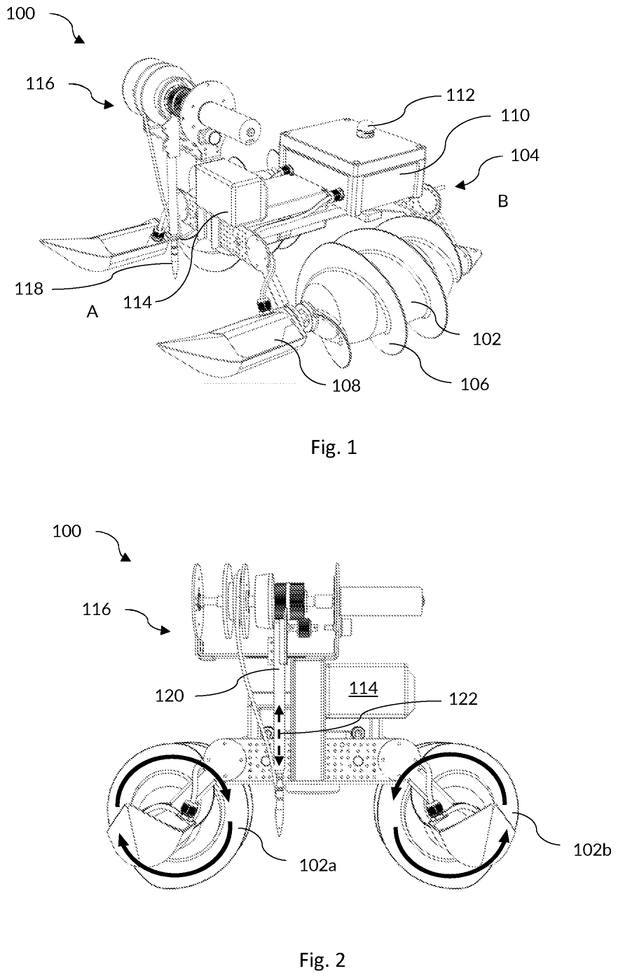

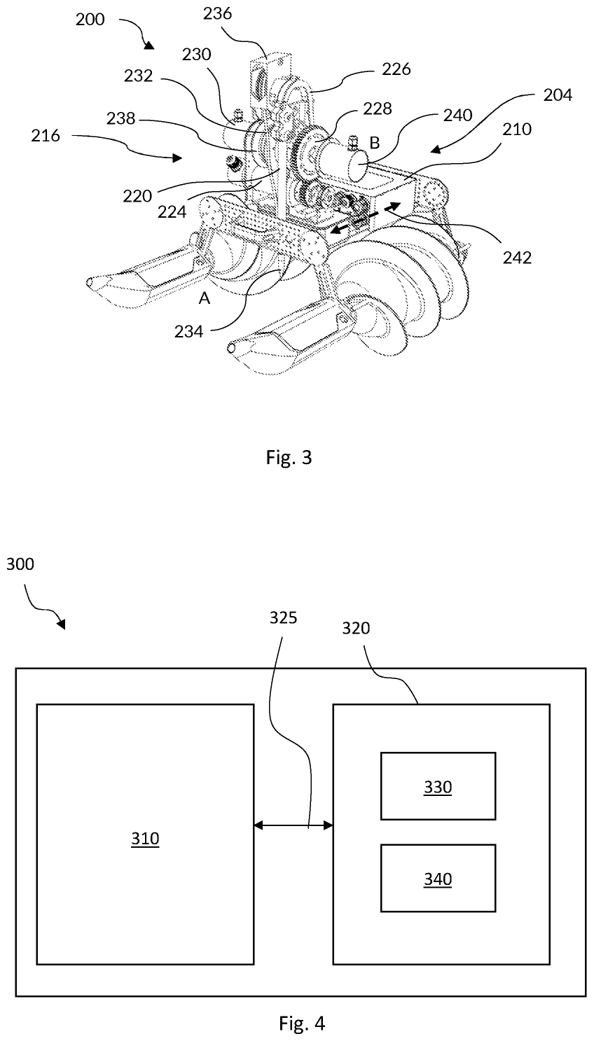

The device 100 shown on FIG. 1 is for moving on a granular medium having one or more slopes. The device 100 includes two rotatable parts 102 in the form of partially hollow pontoons 102, one on each side of a body 104 of the device 100. Each rotatable part 102 includes a number of protrusions 106 which are substantially helical with a thickness, length and pitch. The protrusions 106 may have variations in their length, thickness and pitch. It will be understood that the rotatable parts 102 may have variations in diameter, length and thickness. The application of such variations in protrusions 106 and pontoons 102 can be to reduce drag and ease the motion of the device 100 on the granular medium and also to prevent any external object getting trapped in the rotating pontoon 102, such as a cable. The body 104 defines a front A and a back B, such that the device 100 is typically arranged to move forwards in a direction from B to A. As shown in FIG. 3, the a left pontoon 102a (being positioned on the left to an observer looking at the front of the device 100) typically rotates clockwise to the observer, and a right pontoon 102b (being positioned on the right to the observer looking at the front of the device 100) typically rotates counter-clockwise to the observer. Due to the pitch of the protrusions 106 on each pontoon 102a, 102b, the device 100 moves forward towards the observer. Furthermore, such rotational direction advantageously resists the granular medium accumulating under the device 100 during the operation, which may happen if rotational direction and/or pitch of both pontoons 102a, 102b is reversed.

The device 100 also includes a number of electrical motors (not shown, but housed in this example in skids 108) for causing rotation of the pontoons 102. In this way, the electrical motors can be seen to be placed toward the lower front area of the device 100 as shown in FIG. 1. The skids 108 provide a protective housing for the electrical motors preventing ingress of dust and water (through protection to a certain IP rating). By locating the electrical motors in this way, which are typically among the heavier components of the device 100, a centre of mass of the device 100 is kept low and towards the front of the device 100. As explained hereinbefore, providing the centre of mass towards the front A of the device 100 is beneficial when moving up slopes on the granular medium. The skids 108 have a smoothed profile shaped to provide lifting force to the front of the device 100 preventing it from burrowing into the granular medium and keeping the device above the granular medium, which is especially beneficial when moving on a flat region of the granular medium, or when moving down on a downwardly inclined surface of the granular medium. In this example, the skids 108 include upturned ends to further resist burrowing of the device 100 into the granular medium.

It will be understood that the device 100 also typically includes a number of further components including an enclosure 110 for housing power and control components, an auditory and visual indication system 112 mounted on the enclosure 110, navigation sensors such as cameras 114, and penetration system 116 (alternatively referred to as deployable probe 116).

The purpose of the penetration system 116 is to allow a deployable portion 118 of the deployable probe 116 to penetrate inside the granular medium and take measurements using a number of environmental sensors, and/or collect samples, and/or deliver topical intervention measures (e.g. cold/hot air, pesticides, natural antifungals/insecticides, vibratory action, sound, and more). The penetration system 116 may contain a number of motors, encoders, potentiometers, slip rings, gears, springs, seals to facilitate the required functionality.

One example configuration of the penetration system 116, shown in FIGS. 1 and FIG. 2, includes a number of telescopic tube sections 120 which extend and retract as shown on FIG. 2 with dashed arrow 122.

In operation, the device 100 is connected to an electric power supply, such as via a tethered connection to the enclosure 110 (not shown in FIGS. 1 and 2). The device 100 is also in wired or wireless communication with a user-operated control unit (not shown) including a plurality of user-operable control inputs. To control the device 100, a user operates the control inputs (e.g. buttons) on the user-operated control unit. In response, control signals are communicated to the device 100 from the user-operated control unit, to cause activation of one or more of the motors of the device 100, to thereby cause rotation of the pontoons 102, 102a, 102b, which propels the device 100 on the granular medium. To alter a direction of movement of the device 100 on the granular medium, the user reduces power, changes rotation direction or stops rotation, of one motor while keeping another motor active, by changing their operation of the control inputs on the user-operated control unit. To make the device 100 go backward (in a direction from the front A to the rear B) the rotation direction of both motors is reversed to thereby cause the rotation direction of the pontoons 102 to be reversed, causing backwards movement of the device 100. Once the device reaches the desired destination, the user-operable control inputs are further operated to cause activation of the motor of the penetration system 116, which is connected to a gear engaged with a flexible rack that is arranged to push the telescopic tube sections 120 downward into the granular medium. Once desired depth is reached a measurement is taken using the environmental sensors, stored in memory, such as on a local memory of the device 100, and/or is transferred off the device 100, for example to a web server for subsequent display on a web app. Once the measurement and any other desired actions are completed at the desired depth in the desired location, the telescopic sections 120 are retracted upward out of the granular medium by still further operation of the user-operable control inputs to cause reverse motion of the motor of the penetration system 116.

FIG. 3 shows another example of a device according to the present invention. The device 200 is substantially similar to the device 100 shown in FIG. 1, but includes a different penetration system 216 (sometimes referred to as deployable probe 216), as will be described further hereinafter. The penetration system 216 includes a motor 224, a telescopic tube 220 inside of which is a flexible toothed rack (not visible) placed inside a guided enclosure 226 (the flexible toothed rack might instead be a chain on an alternative flexible mechanism) to provide push/pull connection between a spool driven by the motor 224 through a possible geared linkage 228 and movement of the telescopic tubes 220. A multi-turn potentiometer 230 is used to count revolutions to stop at the right distance and prevent overturning. A sensor cable 232 is provided between an environmental sensor 234 and a microcontroller placed inside enclosure 210. The sensor cable 232 is routed over a cable tensioner device 236 and on to a spool 238. The cable tensioner 236 is used to provide tension to the sensor cable 232 during winding and unwinding as the spool diameter changes while the sensor cable 232 is winding on it. The sensor cable 232 next passes through the centre of the rotational axis of the spool 238 and through a slip ring 240 after which it is directed to the microcontroller placed inside the enclosure 210 for further processing of the readings. In FIG. 3, the routing of the sensor cable 234 from the slip ring to the enclosure 210 is not shown so as to provide better visibility of other elements of the device 200.

Penetration system 216 and each or all of the enclosure boxes 210 either all together or separately can move along the direction of motion of the device 200 as shown with a dashed arrow 242. The purpose of this is to shift the centre of mass depending on the inclination of the device 200 during travel and is beneficial to stability and performance especially when moving uphill and downhill. For example, when moving uphill the centre of mass is shifted towards the front A of the body 204 of the device 200 to prevent device flipping and tilting backward. When moving downhill, the centre of mass is shifted toward the rear B of the body 204 of the device 200 to prevent the device 200 digging inside the granular medium and flipping forward. Although not shown in FIG. 3, it will be understood that the centre of mass can also be shifted laterally by movement of the penetration system 216 and each or all of the enclosure boxes 210 either all together or separately, in a lateral direction.

FIG. 4 is a schematic illustration of a device according to an example of the present invention. The device 300 comprises a plurality of components 310, including at least one or more rotatable parts as described hereinbefore, and a controller 320. The controller 320 is configured to exchange signals 325 with the plurality of components 310 to control the plurality of components 310 in accordance with input signals received by the controller 320, for example from a user-operable control unit (not shown) in wired communication with the device 300. The controller 320 in this example is realised by one or more processors 330 and a computer-readable memory 340. The memory 340 stores instructions which, when executed by the one or more processors 330, cause the device 300 to operate as described herein.

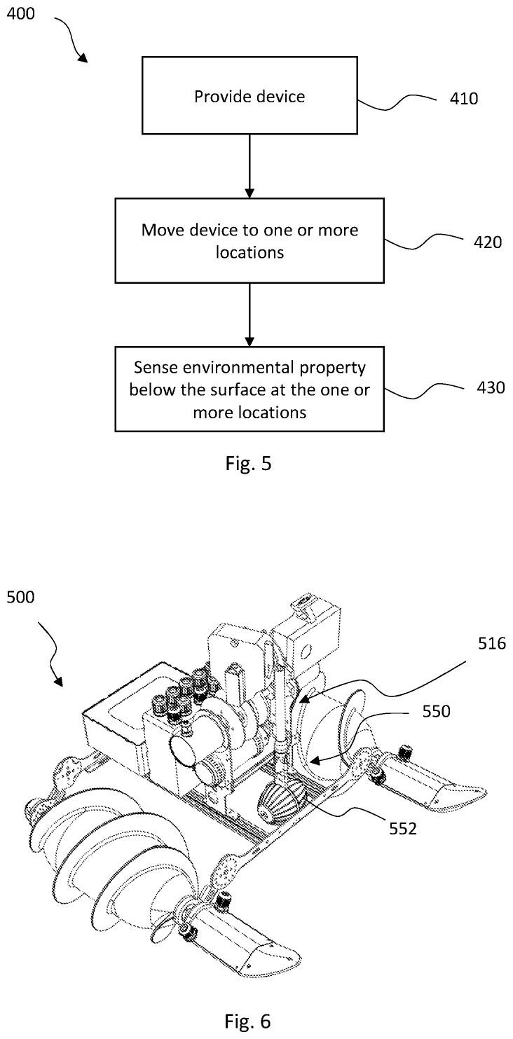

FIG. 5 is a flowchart illustrating a method of controlling a device as described herein. Specifically, the method 400 is a method of using the device described hereinbefore to sense an environmental property of the granular medium beneath the surface of the granular medium, at one or more locations on the granular medium. The method 400 comprises providing 410 a device as described herein, typically having the environmental sensor. The method 400 further comprises moving 420 the device (e.g. causing the device to move) to one or more locations on the surface of the granular medium. Movement between the one or more locations is on the surface of the granular medium. The method 400 further comprises sensing 430 an environmental property (e.g. causing the environmental property to be sensed) below the surface at the one or more locations, using an environmental sensor of the device. The method May further comprise deploying and retracting a deployable probe of the device at each of the one or more locations, so as to position the environmental sensor below the surface of the granular medium.

FIG. 6 shows a device 500 substantially similar to the device 100 of FIGS. 1 and 2, apart from the hereinafter noted differences. The deployable probe 516 is provided with a deployable portion 550 including a propulsion component 552 for propelling the deployable portion 550 of the deployable probe 516 within the granular medium. In this way, the deployable probe 516 can propel itself to the required location within the granular medium. The deployable portion 550 of the deployable probe 516 is releasably and re-attachably attached to the rest of the deployable probe 516. In this example, the propulsion component 552 is in the form of further rotatable parts, and is arranged to burrow within the granular medium.

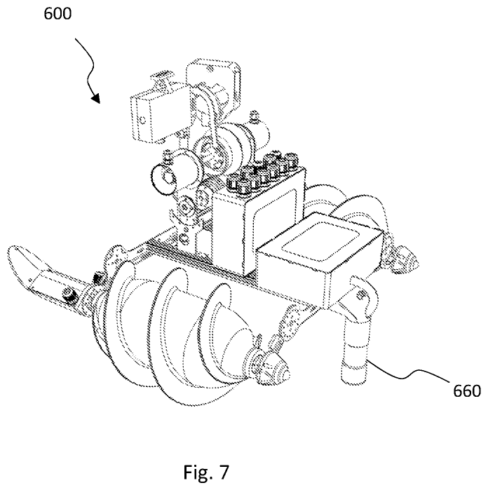

FIG. 7 shows a device 600 substantially similar to the device 200 of FIG. 3, apart from the hereinafter noted differences. The device 600 further comprises a remote sensing component 660 arranged for sensing an environmental property (e.g. density/moisture) of the granular medium below the surface, but from a location at or near the surface of the granular medium. In this example, the remote sensing component (e.g. an ultrasound sensor) is provided at a rear of the device 600.

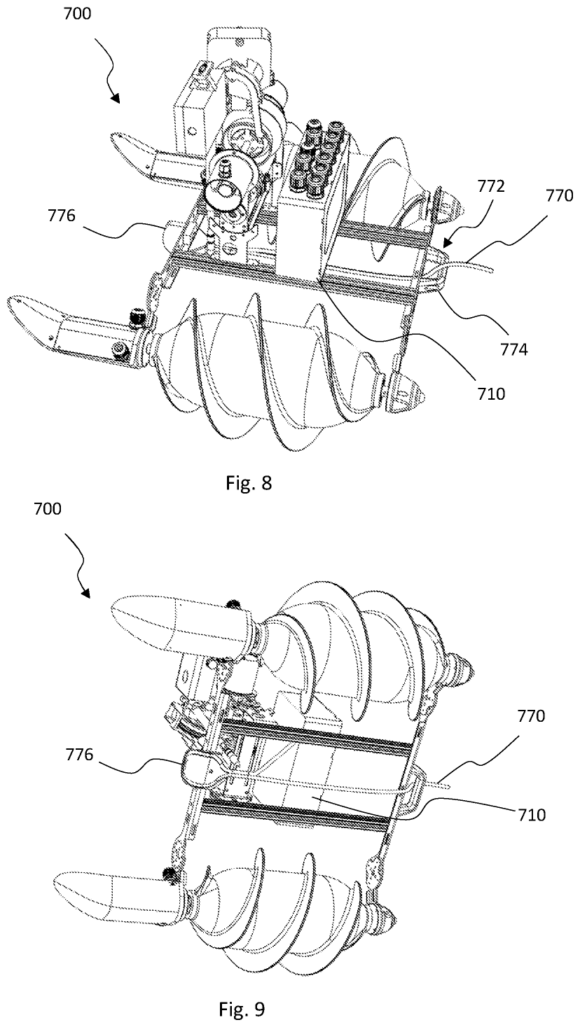

FIGS. 8 and 9 show an example of a device according to the present invention. The device 700 is substantially similar to the device 200 of FIG. 3, apart from the hereinafter noted differences. The device 200 receives power and control signals via a tether 770. The tether 770 is connected to the device 700 via a route which passes through an opening 772 of a handle 774, running on an underside of the device 700, and around a front tether guide 776, before passing back alongside a portion of the tether 770 on the underside of the device 700, and up into the enclosure 710 of the device 700. The tether 770 is secured to itself behind the front tether guide 776 so as to prevent tension forces on the tether 770 being transferred further into the device 700, such as to the enclosure 710. Routing the tether 770 around the front tether guide 776 and beneath the device 700 in this way ensures that when the device is moving uphill on a slope of the granular medium, tension force can be exerted on the tether 770 to cause a slight vertically downwards force to be applied at the front tether guide 776 so as to improve grip of the device 700. In other words, the device 700 is able to effectively and efficiently traverse upwards on steeper inclines than similar devices not having a front tether guide 776. Similarly, when the device 700 is moving downhill on a slope of the granular medium, tension force can be exerted on the tether 770 to cause a slight vertically downwards force to be applied at the handle 774, so as to resist the front end of the device 700 burrowing into the granular medium. Specifically, FIG. 9 shows the underside of the device 700, to better illustrate the routing of the tether 770 around the front tether guide 776.

In summary, there is provided a device (100) for moving on a granular medium including one or more slopes. The device comprises: a body (104) having a front (A) and a rear (B) in a longitudinal direction; and one or more rotatable parts (102, 102a, 102b), each for rotational movement relative to the body (104) about a respective rotational axis having a component aligned with the longitudinal direction, and being externally-exposed to an adjacent portion of a granular medium on which the device (100) is to be provided. The one or more rotatable parts (102, 102a, 102b) each comprise one or more helical fins (106) extending outward from the rotational axis, such that rotation of the one or more rotatable parts (102, 102a, 102b) is configured to cause movement of the device (100) on the granular medium. A first longitudinal distance between a centre of mass of the device (100) and the front (A) of the body (104) is less than a second longitudinal distance between, an expected centre of contact between the device (100) and the granular medium when the device (100) is on a flat portion of granular medium, and the front (A) of the body (104).

Throughout the description and claims of this specification, the words “comprise” and “contain” and variations of them mean “including but not limited to”, and they are not intended to and do not exclude other components, integers, or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, or groups described in conjunction with a particular aspect, embodiment, or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1. A device for moving on a granular medium including one or more slopes, the device comprising:
a body having a front and a rear in a longitudinal direction; and
one or more rotatable parts, each for rotational movement relative to the body about a respective rotational axis having a component aligned with the longitudinal direction, and being externally-exposed to an adjacent portion of a granular medium on which the device is to be provided,
wherein the one or more rotatable parts each comprise one or more helical fins extending outward from the rotational axis, such that rotation of the one or more rotatable parts is configured to cause movement of the device on the granular medium, and
wherein a first longitudinal distance between a centre of mass of the device and the front of the body is less than a second longitudinal distance between, an expected centre of contact between the device and the granular medium when the device is on a flat portion of granular medium, and the front of the body.

2. The device as claimed in claim 1, wherein a difference between the first longitudinal distance and the second longitudinal distance is at least five percent of the distance between the front of the body and the rear of the body.

3. The device as claimed in claim 1, wherein the one or more rotatable parts comprise a first rotatable part on a first lateral side of the body, and a second rotatable part on a second lateral side of the body, and wherein the respective rotational axes of the first and second rotatable parts are mutually symmetric about a longitudinal vertical central plane of the body.

4. The device as claimed in claim 1, further comprising a sensor for sensing an environmental property of the granular medium at a location below the surface.

5. The device as claimed in claim 4, wherein the sensor is at least one of a temperature sensor and a moisture sensor.

6. The device as claimed in claim 1, further comprising a deployable probe configured to be movable between a retracted configuration out of the granular medium and a deployed configuration in which at least a deployable portion of the deployable probe is within the granular medium.

7. The device as claimed in claim 6, wherein the sensor is provided at the deployable portion of the deployable probe.

8. The device as claimed in claim 6, further comprising a deployment mechanism configured to cause the deployable probe to move between the retracted configuration and the deployed configuration.

9. The device as claimed in claim 8, wherein the deployment mechanism comprises an electric motor in geared relationship with the deployable probe.

10. The device as claimed in claim 9, wherein the deployment mechanism further comprises a position sensor to measure a deployment parameter indicative of a deployment depth of the deployable portion of the deployable probe, optionally wherein the position sensor is a potentiometer and wherein the deployment parameter is an electrical resistance of the potentiometer.

11. The device as claimed in claim 6, wherein the deployable probe defines one or more suction inlets in fluid communication with a suction supply of the device, arranged to draw the deployable probe into the granular medium.

12. The device as claimed in claim 6, wherein the deployable probe comprises a propulsion component for propelling the deployable probe within the granular medium.

13. The device as claimed in claim 1, wherein at least one of the one or more rotatable parts comprises a central core from which the one or more helical fins extend, optionally wherein the central core has a radius transverse to the axis of rotation of greater than a radial extent of the one or more helical fins from the central core.

14. The device as claimed in claim 11, wherein the central core comprises a first end region and a second end region and a central region therebetween, and wherein a radial extend of the central region is greater than a radial extent of either of the first end region and the second end region.

15. The device as claimed in claim 1, further comprising one or more skids to support the body on the granular medium.

16. The device as claimed in claim 1, wherein the granular medium is grain.

17. The device as claimed in claim 1, wherein the device is configured to be connected to an external support component and/or power supply via a tether, and wherein the device comprises a tether attachment at the front of the body, arranged to route the tether to the rear of the body, beneath the body of the device.

18. The device as claimed in claim 1, further comprising one or more motors configured to cause movement of the one or more rotatable parts, and wherein the one or more motors are located in a front portion of the body.

19. A method of surveying an environmental property of a granular medium at one or more locations below the surface of the granular medium, the method comprising:
providing the device as claimed in claim 4;
operating the device to move the device over the granular medium to one or more locations; and
outputting the sensor output of the device indicative of the environmental property of the granular medium below the surface at the one or more locations.

20. The method as claimed in claim 19, when the device includes deployable probe configured to be movable between a retracted configuration out of the granular medium and a deployed configuration in which at least a deployable portion of the deployable probe is within the granular medium;
further comprising deploying the deployable probe at each of the one or more locations.
